(19) United States
(12) Patent Application Publication
(10) Pub. No.: US 2003/0125964 A1
(43) Pub. Date: Jul. 3, 2003

(54) System and method for controlling distribution of digital copyrighted material using a multi-level marketing model

(76) Inventors: Grace Tsui-Feng Chang, Richardson, TX (US); Michael Abraham Epstein, Spring Valley, NY (US)

Correspondence Address: PHILIPS ELECTRONICS NORTH AMERICAN CORP, 580 WHITE PLAINS RD, TARRYTOWN, NY, 10591, US

(21) Appl. No.: 10/029,997

(22) Filed: Dec. 27, 2001

(51) Int. Cl. G06F 17/60

(52) U.S. Cl. 705/1

(57) ABSTRACT

A system and a method for tracking marketers/distributors of a digital product is provided, using a multi-level marketing business model, including the steps of storing user data associated with a plurality of registered users, wherein said user data includes a user identification code (userID) corresponding to each registered user of the plurality of users; transferring a data packet associated with the digital product by a registered user of the plurality of registered users to another user, wherein the data packet includes a watermark storing the userID of the registered user; and updating the watermark to include the userID of the registered user who transferred the data packet; and processing payment information corresponding to the registered user who transferred the data packet for effecting payment to the registered user for the sale of the digital product by the registered user to the user.

### BACKGROUND OF THE INVENTION

In the digital recording environment, a challenge exists for assuring copyright protection to owners and merchants of copyrighted digital material, such as digital video, music, gaming, functional and educational software, shareware and literary products. Not only is there a need to enforce prevention of pirating of digital copyrighted material, but also there is a need to provide an incentive for individuals to obtain legal copies of digital copyrighted products. Furthermore, there is a need for minimizing the cost to owners and merchants of copyrighted digital products associated with the marketing and distribution of the digitalized copyrighted products, in order that cost of the products to consumers will be reduced, for further promoting legal acquisition of the products.

Present business models for distribution of copyrighted digital products in which consumer's of copyrighted digital products participate in and benefit from marketing of the copyrighted digital products include multi-level marketing (MLM) models. In the MLM model, digital products developed and owned by different developers are distributed through a central server. The developer and owners (buyers that purchased the product) establish a catalogue on a network server (selected by the developer or buyer) from which products owned by the developer or owner may be selected.

A buyer may browse a catalogue established by a developer or owner and select a product. The buyer connects to the central server to purchase the product, after which the buyer may establish a catalogue for selling product(s) that he owns. Thus, the product may have been purchased by and sold via multiple levels of owners. Commission is paid, through the central server, to the owner that established a catalogue for the purchase of a product via the catalogue. A commission is further paid to each previous level owner of the product, where the commission decreases for each level that the owner is removed from the present purchase. This model also controls distribution of illegal copies of the product by providing security measures to prevent execution of the product once it has been used improperly, such as by having been transferred to a computer “outside” the multi-level scheme.

However, the prior art MLM models do not allow direct peer-to-peer distribution or marketing of the product. In order for an owner of a product to market the product, the owner places an advertisement for the product on a first server that is accessible by potential buyers. The owner does not market directly to peers. A further disadvantage of prior art MLM models is that the procedure for purchasing a product is cumbersome. The potential buyer must access the advertisement placed by the owner via the first server. If the potential buyer finds a product that he would like to purchase he must next access a second server for transacting the purchase, and accurately enter purchase order information provided in the advertisement in order to purchase and obtain the product.

Therefore, a need exists for a system and method for direct peer-to-peer marketing of copyrighted digital products, in which the seller and purchaser of a copyrighted digital product are rewarded or compensated.

Furthermore, a need exists for a system and method for providing a procedure for purchasing and acquiring a copyrighted digital product marketed via peer-to-peer marketing.

In addition, a need exists for a system and method for peer-to-peer distribution of promotional material for marketing a copyrighted digital product.

### SUMMARY OF THE INVENTION

It is an object of the present invention to provide a system and a method for direct peer-to-peer marketing of copyrighted digital products, in which the seller and purchaser of a copyrighted digital product are rewarded or compensated and illegal distribution of the copyrighted product is substantially prevented.

It is another object of the present invention to provide a system and method for providing a simple procedure for purchasing and acquiring a copyrighted digital product distributed via peer-to-peer marketing, such as a multi-level marketing (MLM) business model.

It is yet another object of the present invention to provide a system and method for peer-to-peer distribution of promotional material for marketing a copyrighted digital product.

Finally, it is another object of the present invention to provide a system and a method for improving efficiency of transacting, recording and reporting of each legal transfer of a copy of a copyrighted digital product.

The above and other objects are achieved by a system and method for marketing and distributing copyrighted digital products over a communication network, such as the Internet. According to the present invention, a method is provided for tracking marketers/distributors of a digital product, including the steps of storing user data associated with a plurality of registered users, wherein the user data includes a user identification code (userID) and payment information corresponding to each registered user of the plurality of registered users; transferring a data packet associated with the digital product from a registered user of the plurality of registered users to another user, wherein the data packet includes a watermark storing the userID of the registered user; transacting a purchase by the user of the digital product; and processing the payment information corresponding to the registered user who transferred the data packet for effecting payment to the registered user for the sale of the digital product by the registered user to the user.

Furthermore, in accordance with the present invention a system is provided including a vendor server and a consumer server for tracking marketers of a digital product. The vendor server includes a processor executing computer code for performing functions including: storing user data associated with a plurality of registered users, wherein the user data includes a user identification code (userID) and payment information corresponding to each registered user of the plurality of registered users; receiving watermark history data associated with a product, the watermark history data including the userID corresponding to registered users who have transferred a file associated with the product for marketing the product; transacting a purchase of the product by a user; and updating payment information corresponding to the registered users who have transferred the file.

The consumer includes a processor executing computer code for performing functions including: receiving a data packet associated with a digital product marketed by a user of another processor, wherein the data packet includes a watermark storing history data including identification for each user that transferred the data packet to another user and a product content file; transmitting the history data; transacting a purchase of the digital product; and receiving decryption data for decrypting the product content file.

### BRIEF DESCRIPTION OF THE FIGURES

FIG. 1 is a tree graph of a system for marketing copyrighted digital products in accordance with the present invention;

FIG. 2 is a tree graph diagram of the relationship of initialization data within the system for marketing copyrighted digital products in accordance with the present invention;

FIG. 3 is a tree graph diagram showing the flow of data when transacting a sale of a copyrighted digital product in accordance with the present invention;

FIG. 4A is a block diagram of software modules included in a vendor software module in accordance with the present invention;

FIG. 4B is a block diagram of software modules included in a purchase software module in accordance with the present invention;

FIG. 4C is a block diagram of software modules included in a transfer software module in accordance with the present invention;

FIG. 5 is a flow diagram of the steps performed by the transfer software module in accordance with the present invention;

FIG. 6A is a flow diagram of the steps performed by the purchase software module during purchase of a digital copyrighted product in accordance with the present invention;

FIG. 6B is a flow diagram of the steps performed by the purchase software module upon transacting a purchase of a digital copyrighted product in accordance with the present invention;

FIG. 7 is a flow diagram of the steps performed by the vendor software module while transacting a purchase of a digital copyrighted product in accordance with the present invention;

FIG. 8 is a flow diagram of the steps performed by a consumer during transfer of a files associated with a digital copyrighted product to another consumer in accordance with the present invention; and

FIG. 9 is a flow diagram of the steps performed by a consumer when purchasing a digital copyrighted product in accordance with the present invention.

### DETAILED DESCRIPTION OF THE INVENTION

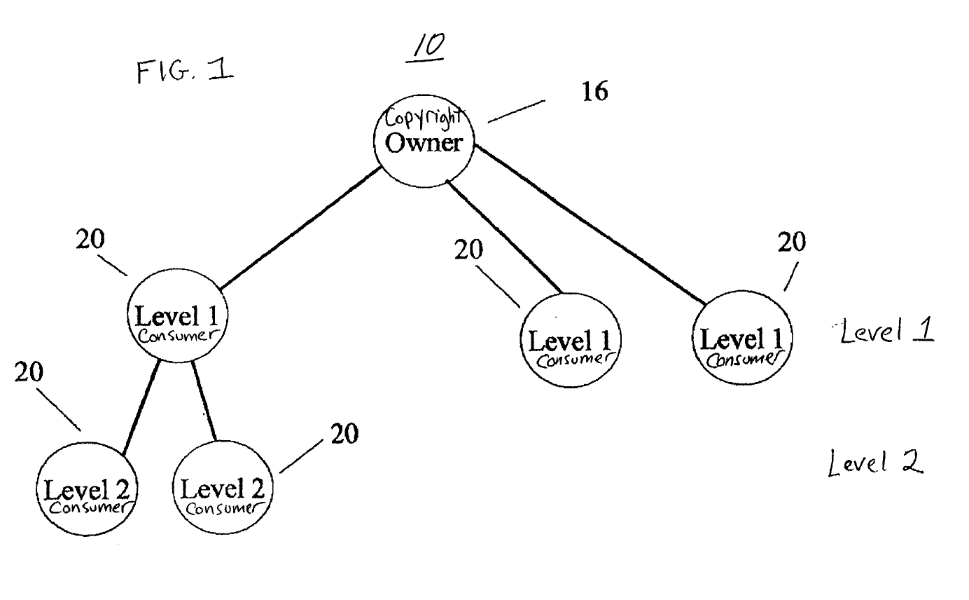

The present invention provides a system and method for peer-to-peer marketing and distributing of copyrighted digital products, and tracking of rewards for successful marketing, based on a multi-level marketing (MLM) business model. With reference to FIG. 1, there is shown an exemplary tree graph 10 showing marketing and distribution of a copyrighted digital product using an MLM business model.

A copyright owner 16 of the digital product markets and distributes the digital product to a plurality of consumers 20 by allowing each consumer 20 to market and distribute the product to another consumer 20. The copyright owner 16 initially distributes the product, such as a digital book, music, movie, software application or game, to one or more level 1 consumers 20. The copyright owner 16 preferably distributes the product to the one or more level 1 consumers 20 by transmitting the product via a network facility, by mailing a computer-readable medium, such as a compact disc, optical disc, diskette, etc., storing the product to the level 1 consumers, and/or by the one or more level 1 consumers 20 downloading the product from a computer terminal/server associated with the copyright owner 16. Other methods of distributing the product by the copyright owner 16 can be used within the context of the present invention. Each level 1 consumer 20 may distribute a copy of the digital product to one or more level 2 consumers 20.

The distribution of the digital product may continue via peer-to-peer marketing and distribution, where each level n consumer 20 has re-selling rights for distributing the digital product to one or more level n+1 consumers 20. The copyright owner 16 rewards each level n consumer 20 that distributed the digital product to a level n+1 consumer 20 for procuring a sale, such as, by a commission. Furthermore, the copyright owner 16 rewards each level n consumer 20 for sales procured by the level n+1 consumer 20 and for sales procured by successive levels of consumers 20 by a commission, where the commission is decreased for each level removed from the level n consumer 20 in accordance with an MLM business model.

The current invention provides a method in which contact between peer-to-peer consumers 16 and marketers of the product with the copyright owner 16 is minimized, and tracking and storing of history data including identifications of consumers 20 that market the product is performed by processors operated by the consumers 20 and a watermark embedded in the product (e.g. music, graphics video etc), so that the copyright owner 16 is relieved from tasks associated with tracking and storing history data.

It is to be understood that there are various existing MLM business models. For example, it is common for an MLM business model to employ a practice known as “breakage” by limiting the number of transfers allowed for a product or the number of commissions to be paid for each transfer. Breakage limits and/or caps commissions paid per consumer in order to increase revenue by the original owner of the product. The current invention is not directed to a particular MLM business model, but may be applied to existing MLM business models as well as MLM business models that are developed in the future.

A watermark typically is a signal and/or data that is embedded in a product (video, audio, software etc.) in such a way that it does not interfere with the known use of the product, yet can be detectable in a convenient reliable manner. For example, a watermark in an audio signal is inaudible even to a trained listener. The watermark is also typically irremovable from the encoding of the content material, so that attempting to remove the watermark causes damage to the content material. One purpose of the watermark is to provide proof of authenticity. In certain applications of a watermark, it is known in the art to update a watermark attached or embedded in a file with the identification of a user who transfers the file.

The watermark used in the present invention is embedded within a preview file PF associated and with a product content file F of a product, for storing at least a product identification code and history data associated with consumers 20 that transferred the preview file PF. When a consumer 20 transfers the preview file PF to another consumer 20, the history data stored by the watermark is updated with an identification code corresponding to the other consumer 20. Upon the other consumer 20 purchasing the product, the updated history data of the watermark is provided to the copyright owner 16 for assuring payment of a commission to the consumer 20 that successfully procured the sale. The watermark cannot be tampered with by the consumers or other users and can only updated by software provided by the copyright owner 16.

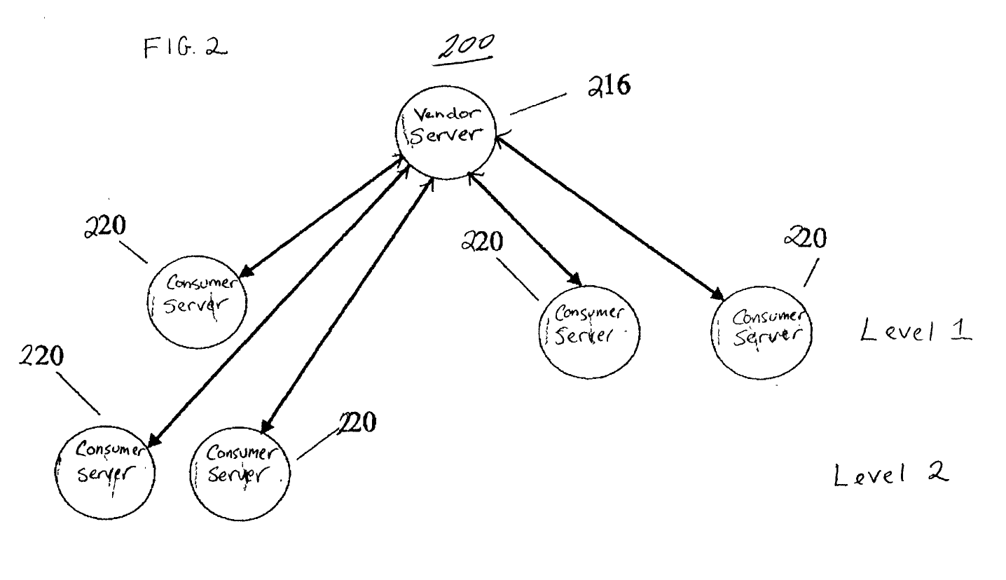

FIG. 2 shows a tree graph diagram of a system 200 in which consumer data is provided by consumer servers 220, where each consumer server 220 is operated by a consumer 20, to a vendor server 216 operated by the copyright owner 16; and purchase and/or transfer software modules are transferred from the vendor server 216 to the consumer servers 220, for example, via an Internet or e-mail based download operation, or removable storage means, such as a CD-ROM. Communication between the vendor server 216 and the consumer servers 220 is provided by a computer network, where the computer network is any network means for connecting one or more processors, as is known in the art, and the computer network is preferably the Internet.

The vendor server 216 and the consumer servers 220 each include one or more processors, one or more storage means, user interface(s) and wired or wireless communication means for communicating via the computer network, as is known in the art. The vendor server 216 and each consumer server 220 are capable of executing software for communicating via the Internet, such as a network browser, as is known in the art. The consumer servers 220 are capable of executing the software received from the vendor server 216.

The consumer data is initially provided by each consumer server 220 to the vendor server 216 during a registration session, and may be updated by the consumer 20. Consumer data includes, for example, consumer name, mailing address, e-mail address, telephone number, billing information regarding payment for purchases, etc. Consumers 20 may optionally provide payment information, including method and/or an account number for receiving payment of commission. At registration, the vendor server 216 assigns an identification code IDnnnn for identifying each consumer 20, and the identification code IDnnnn is stored by the vendor server 216 as well as by the consumer server 220 for retrieval by the vendor server 216 or the transfer and purchase software modules. The IDnnnn may be unknown by the consumer 20.

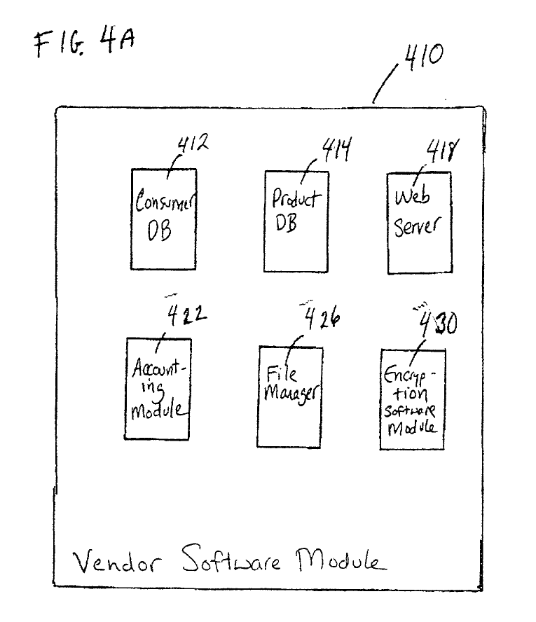

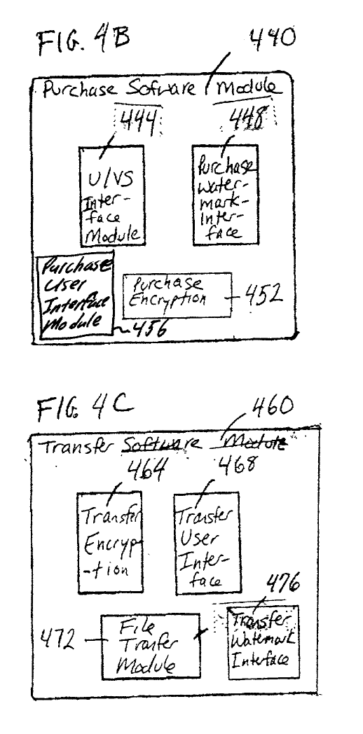

The purchase and transfer software modules provided by the vendor server 216 to one of the consumer servers 220 include a purchase software module to be executed by the consumer server 220 for transacting a purchase of the product, and a transfer software module for distributing the product to another consumer server 220. The purchase and transfer software modules are discussed further below with reference to FIGS. 4B and 4C, respectively.

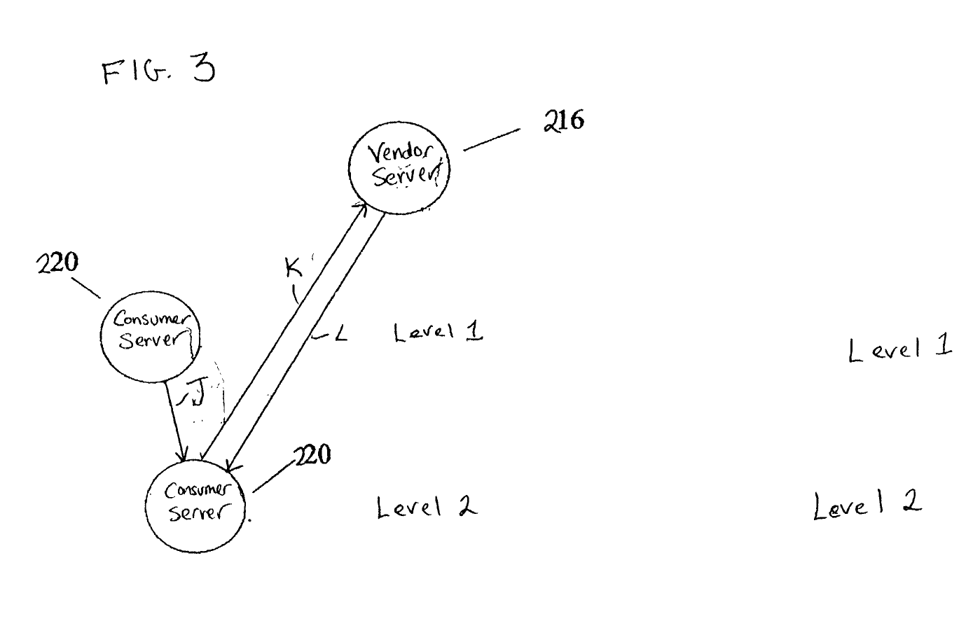

FIG. 3 shows data flow during distribution of the product from the consumer server 220 of a level 1 consumer 20 to the consumer server 220 of a level 2 server, and during purchase of the product by the level 2 server from the copyright owner 20. It is to be understood that the level 1 consumer 20 may be any level n consumer 20, and the level 2 consumer may be any level n+1 consumer. The data flows via a computer network, where the computer network is any network means for connecting one or more processors, as is known in the art, and the computer network is preferably the Internet.

Data flow J indicates the transfer of a data package from the level 1 consumer to the level 2 consumer. The data package transferred in data flow J includes an encrypted product content file F including content of the product, identification of the product, such as a product PIDxxxx, associated with the level 1 consumer transferring the data, a public key Kxxxx_{pub} associated with the level 1 consumer, and a public key Kowner_{pub} of the copyright owner 16; an encrypted session key Kₛ, as is known in the art; and a preview file PF associated with the product content file F with an embedded updated watermark. Preferably the watermark is also embedded in the product F. The watermark stores the product identification code of the product associated with the watermark and history data including the identification codes IDnnnn corresponding to each consumer 20 that transferred the product. In this example the watermark's history data includes the identification code corresponding to the level 1 consumer 20.

Data flow K shows the flow of a purchase data packet associated with purchase of the product by the level 2 consumer. The purchase data includes information needed by vendor server 216 for transacting the purchase including an identification code associated with the level 2 consumer 20 purchasing the product, the session key K, in an encrypted form, and the watermark associated with the product in an encrypted form.

Data flow L shows the flow of a decryption key to the level 2 consumer 20. The decryption key Kₛ is encrypted using the public key Kyyyy_{pub} associated with the level 2 consumer 20, and the encrypted session key.

FIG. 4A shows a vendor software module 410 stored and executed by the vendor server 216. The vendor software module 410 includes a consumer database 412, a product database 414, a web server 418, an accounting module 422, a file manager software module 426, and an encryption software module 430. The consumer database 412 stores, accesses and updates the consumer data for each registered consumer 20, where the consumer data further includes commission data indicating commission already paid and commission to be paid to the consumer 20.

The product database 414 stores, accesses and updates a product identification number, a product content file F including content data of the product, a product preview file PF including a preview of content data of the product, and price data. The web server 418 provides interfacing means, such as web pages, for interfacing between the vendor server 216 and consumer servers 220 for obtaining information from consumers 20, handling consumer 20 requests, providing information to consumers 20, etc.

The accounting software module 422 module records, tracks, calculates and facilitates payments for products and paying of commissions in accordance with the MLM business model. Payments for products and paying of commissions may be by money exchanged via a credit card, an Internet-based account or by another tender, as is known in commerce. For example, commission may be provided as sale credit, points accrued having a credit value, limited edition products, chat sessions with an artist featured in the product line, preferential seating for a performance by an artist, sneak preview of products before release to public, etc.

The accounting software module 422 consults the commission to be paid information stored in the consumer database 412 for determining commissions to be paid. Payment may be made upon transaction of a purchase, or at regular intervals, such as monthly. The accounting software module 422 receives decrypted data from data flow K from the encryption module 430. Upon a successful purchase transaction the accounting software module 422 updates the commission to be paid data of the consumer database 412 based upon the watermark history data and watermark product data of the decrypted watermark. Next, the accounting software module 422 transmits a purchase complete signal to the encryption module 430 for signaling the encryption module 430 that a purchase was completed for the product. The purchase complete signal includes the session key Kₛ, the identification of the consumer 20 such as the userID of the consumer 20 that purchased the product and preferably includes identification of the product, such as the product identification number (PID).

The file manager software module 426 handles managing and transferring of a product content file F and associated preview files PF between the vendor server 216 and the consumer server 220 operated by a level 1 consumer 20 that purchased a product directly from the copyright owner 20. File transfer may be performed using technology that is known in the art, such as via email, or proprietary methods.

The encryption software module 430 secures and/or encrypts a product content file F that is being transferred by the file manager software module 426. The encryption software module 430 further decrypts encrypted information received from a consumer server 220 through data flow K. The decrypted watermark data is transferred to the accounting software module 422 for processing of the decrypted information. Upon receipt of a purchase completion signal from the accounting module 422, the encryption software module 430 decrypts the session key Kₛ, and encrypts the session key Kₛ using the public key Knnnn_{pub} of the consumer 20 that purchased the product and provides it for transmission to the consumer server 220 operated by the consumer 20 as data flow L. The encryption software module 430 further randomly (or non-randomly) generates and assigns to each consumer 20 an IDnnnn, a public key Knnnn_{pub}, and a private key Knnnnₚᵣᵥ as is known in the art. The encryption software module 430 further generates and assigns to itself its own public key Kowner_{pub}, and its own private key Kownerₚᵣᵥ as is known in the art.

FIG. 4B shows the purchase software module 440 that is stored and executed by a consumer server 220 operated by a consumer 20. Preferably, the purchase software module 440 operates as an interface with a network browser for establishing communication with the vendor server 216. The purchase software module 440 includes a user/vendor server (u/vs) interface module 444 for providing communication between the consumer 20 and the vendor server 16, a purchase watermark interface module 448 for extracting the watermark associated with the product, a purchase encryption module 452, and a purchase user interface module 456 for facilitating communication between the consumer 20 and the purchase software module 440. The watermark interface module 448 extracts the watermark from the preview file PF associated with the product. The purchase encryption module 452 encrypts the watermark to prevent tampering of the watermark by the consumer 20. The user/vendor server interface module 444 transmits the data flow K, including the encrypted watermark, the encrypted session key Kₛ and the public key Kyyyy_{pub} associated with the consumer 20 that wishes to purchase the product, to the vendor server 216.

FIG. 4C shows the transfer software module 460 stored and executed by the consumer server 220 operated by a consumer 20. Preferably, the transfer software module 460 operates on the consumer server 220 independent of the vendor server 216. The transfer software module 460 includes a transfer encryption module 464 for selecting the session key Kₛ to be used for transactions related to transfer of a product content file F to another consumer 20, a transfer user interface module 468 for communicating with the consumer 20, a file transfer module 472 for transferring the data package of data flow J to the other consumer server 220, and a transfer watermark interface module 476 for updating the watermark associated with a product being transferred with the consumer's identification data IDxxxx.

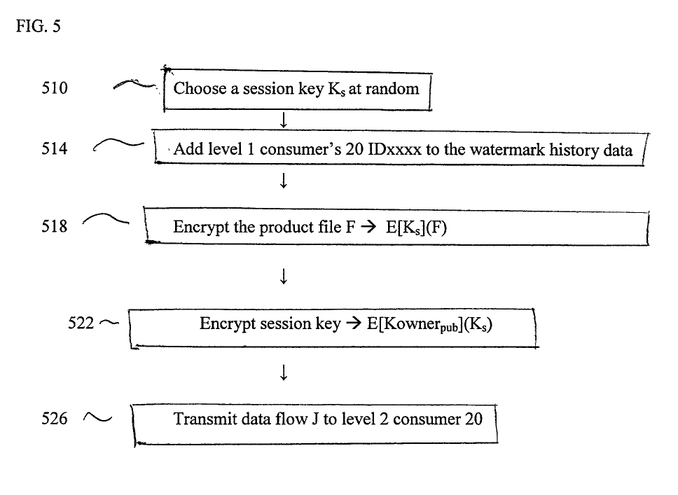

FIG. 5 shows exemplary steps performed by the transfer software module 460 executed on the consumer server 220 operated by the level 1 consumer as he markets and/or distributes a product to the level 2 consumer 20, as shown in FIG. 3. At step 510, the transfer encryption module 464 generates a random session key Kₛ. It is possible for the session key Kₛ to be assigned in a nonrandom manner. At step 514, the transfer watermark interface module 476 updates the watermark by adding the consumer's IDxxxx to the watermark's history data. At step 518, the transfer encryption module 464 encrypts the product content file F in accordance with the session key Kₛ. At step 522, the transfer encryption module 464 encrypts the session key in accordance with E[Kowner_{pub}](Kₛ). At step 526 the file transfer module 472 transmits data flow J to the level 2 consumer 20. The file transfer module 472 may interface with a known file transfer means such as e-mail for transferring data flow J, or may perform file transfers using proprietary software operating on a network connecting the consumer servers 220 of the level 2 consumer 20 and the level 1 consumer 20. Preferably, the network is the Internet.

It is to be understood that the transfer software module 460 is capable of transferring a data flow J to more than one level 2 consumer 20, and one or more data flows J may be transferred to each level 2 consumer 20, each data flow J corresponding to a different product. The multiple data flows J may be transferred at different times or virtually simultaneously.

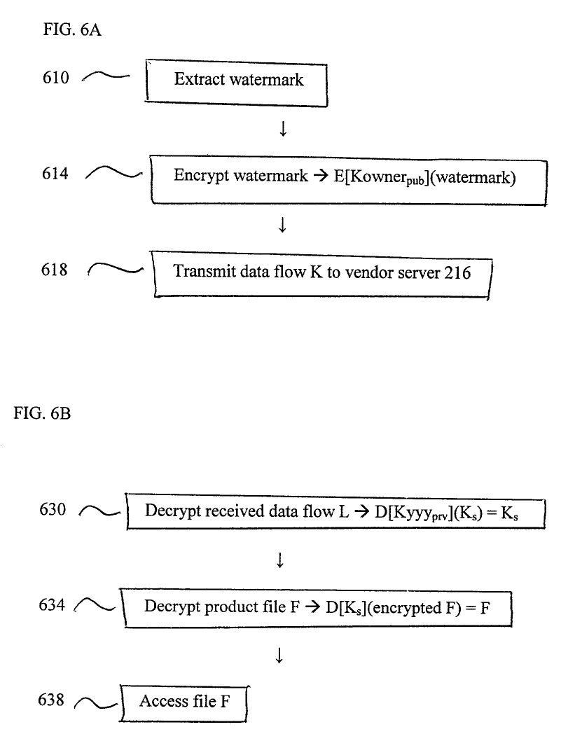

FIG. 6A shows exemplary steps performed by the product software module 440 executed on the consumer server 220 operated by the level 2 consumer 20 as the level 2 consumer 20 receives the product from the level 1 consumer 20 and purchases the product, as shown in FIG. 3. At step 610, the purchase watermark interface module 448 extracts the watermark. At step 614, the purchase encryption module 452 encrypts the watermark in accordance with E[Kowner_{pub}](watermark). At step 618, the user/vendor server interface module 444 transmits the data flow K to the vendor server 216.

FIG. 6B shows exemplary steps performed by the product software module 440 executed on the consumer server 220 operated by the level 2 consumer as the level 2 consumer receives the decryption key for the product he purchased, as shown in FIG. 3. At step 630, the purchase encryption module 452 decrypts the data flow K received in accordance with D[Kyyyyₚᵣᵥ](Kₛ)=Kₛ. At step 634 the purchase encryption module 452 decrypts the product content file F associated with the product in accordance with D[Kₛ](encrypted F)=F. At step 638, the product software module 440 accesses the product content file F for the level 2 consumer to use or store in a selected location.

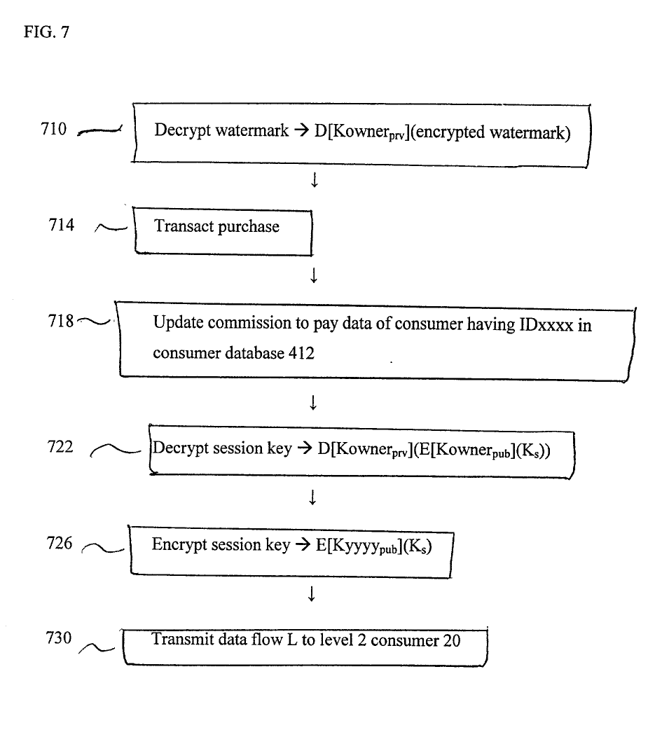

FIG. 7 shows exemplary steps performed by the vendor software module 410 executed on the vendor server 216 upon receiving a data packet transferred in data flow J. At step 710, the encryption software module 430 decrypts the encrypted watermark of the data packet in accordance with D[Kownerₚᵣᵥ]. At step 714 the accounting module 422 transacts the purchase. The accounting module 422 accesses the billing information associated with the purchasing consumer 20 stored in the consumer database 412 for retrieving an account number such as a credit card number for obtaining funds. The accounting module 422 verifies that the account is valid and that funds are available and retrieves the funds, or else the transaction is terminated and the web server 418 provides the purchasing consumer 20 with a “terminate transaction due to poor credit” message.

At step 718, the accounting module 422 updates the consumer database 412 by updating the commission to pay data associated with the consumer IDxxxx last added to the watermark's history data, or depending on the MLM system many consumers that are part of the transaction. Payment of commission is not within the scope of the invention. At step 722, the encryption software module 430 decrypts the session key received in the data packet, in accordance with D[Kownerₚᵣᵥ](E[Kowner_{pub}](Kₛ)). At step 726, the encryption software module 430 encrypts the session key with the public key of the consumer that has purchased the content E[Kyyyy_{pub}](Kₛ). At step 730, the encryption software module 430 provides the data flow L to the purchasing consumer 20.

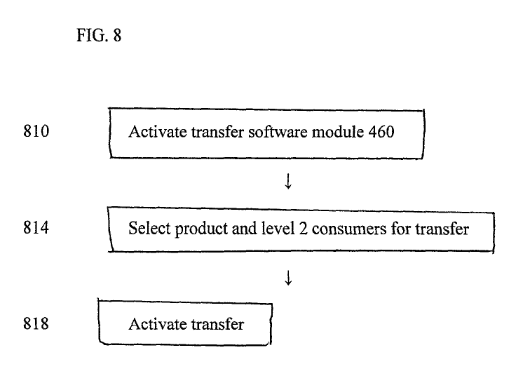

FIG. 8 shows exemplary steps performed by the level 1 consumer 20 in accordance with FIG. 3. At step 810, the level 1 consumer 20 activates the transfer software module 460. The transfer user interface 468 of the transfer software module 460 provides a means such as a GUI by which the level 1 consumer 20 makes requests and selections. At step 814, the level 1 consumer 20 selects one or more products to transfer. For each product selected, the level 1 consumer 20 selects one or more level 2 consumers to which the product will be transferred. At step 818, the level 1 consumer 20 activates the transfer.

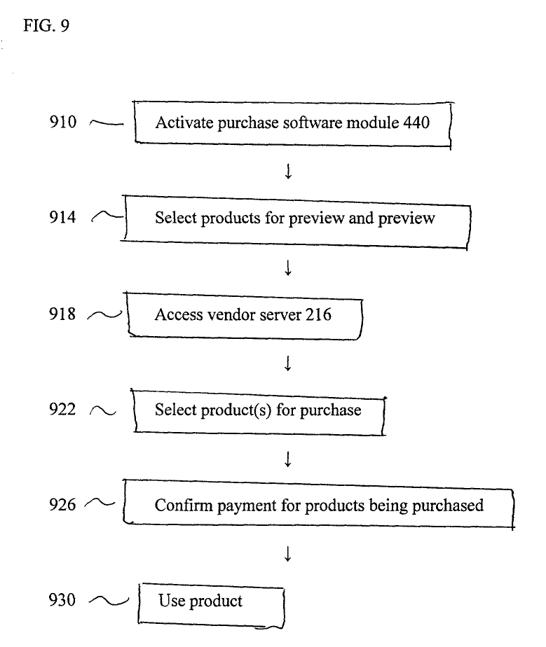

FIG. 9 shows exemplary steps performed by the level 2 consumer 20 when purchasing one or more products, in accordance with FIG. 3. The purchase user interface module 456 of the purchase software module 440 provides a means such as a GUI by which the level 2 consumer 20 makes requests and selections. At step 910, the level 2 consumer 20 activates the purchase software module 440. At step 914, the level 2 consumer 20 requests to preview a product and selects the preview file he wishes to execute. The preview file provides a preview of the product, such as wherein the product is a song the preview file contains 15 seconds of a song. In the preferred embodiment of the invention the preview file PF associated with at least one product has already been transferred to the level 2 consumer's consumer server 220 for his preview, as discussed above.

The purchase user interface 456 prompts the level 2 consumer 20 to select the preview file PF he wishes to preview. The selected preview file PF may be executed using compatible software stored by the level 2 consumer's consumer server 220, as is known in the art. The compatible software is selected automatically by the level 2 consumer's consumer server 220 or by the level 2 consumer, as is known in the art, depending on the type of data stored in the preview file PF. Alternatively, the preview file PF may be executed using proprietary software provided by the purchase software module 440.

At step 918, the level 2 consumer 20 accesses the vendor server 216 and signs on to the vendor server's 216 website by providing a user name and password established at the time of registration by a method known in the art. The level 2 consumer 20 may access the vendor server's 216 website by conventional means via the Internet, or the purchase software module 440 may link the level 2 consumer's consumer server 220 to the vendor server's 216 website.

In one aspect of the invention, the level 2 consumer 20 may be able to access a web page via the vendor server's 216 web site through which the level 2 consumer may browse directly through the preview files PF of the product database 414.

At step 922, the level 2 consumer 20 uses web pages provided by the vendor server's 216 web site to request to make a purchase and to select one or more products for purchase.

At step 926, the level 2 consumer 30 confirms purchase and approves payment for the purchase. Methods of payment are known in the art and are not within the scope of the invention. It is possible that an action may be required by the level 2 consumer for activating the decryption key provided via data flow L in order to activate decrypting of the product content file F. Preferably the decryption is activated automatically upon receipt of the decryption key. At step 930, the level 2 consumer accesses and uses the product(s).

Alternatively, the preview file PF may be provided with a direct link to the purchasing software module 440 and/or the vendor server 216. The level 2 consumer may purchase software by performing the steps shown in FIG. 9, skipping step 910, and beginning by accessing a preview file PF transferred to him by the level 1 consumer 20 and activating the link to the purchasing software module 440 or vendor server 216, at which point the level 2 consumer 20 signs on and requests to make a purchase.

The level 2 consumer is now entitled to install, execute and market the product(s) in accordance with the terms established by the MLM business model adhered to by the vendor server 16. The level 2 consumer may now perform the steps of FIG. 8 for transferring the product to a level 3 consumer for executing a re-sale of the product. If the level 2 consumer has not done so yet, he must obtain the transfer software module 460 and provide payment information for receiving commission payments to the vendor server 216.

Preferably, prior to transfer to the level 2 consumer 20, the product content file F is provided with protective security measures by the transfer encryption module 464 for frustrating improper use of the product content file F. Preferably, the user is allowed to make one backup copy, such as burning a CD.

Preview files PF stored by (or for) the level 2 consumer associated with products that are purchased may be saved in association with the product content file F for future marketing purposes, while those preview files associated with products not selected for purchase may be deleted along with other parts of the rejected product such as the encrypted content F.

In another embodiment of the invention, the purchase software module 440 and/or transfer software are stored and executed by the vendor server 216. The user of consumer server 220 accesses and uses the purchase software module 440 and/or transfer software module 460 by establishing communication with the vendor server 216, such as by signing on to the website provided by the vendor server 216, and requesting to purchase or transfer a product.

In another embodiment of the invention, the transfer software module 460 is stored and executed by the consumer server 220 and includes an interface module for facilitating communication between the consumer server 220 and the vendor server 216, where the transfer software module 460 operates as an interface with a network browser for establishing communication with the vendor server 216. A level n consumer 20 may use the transfer software module 460 to transfer the files associated with a product to a storage area provided by the vendor server 216 assigned to a level n+1 consumer 20. The vendor server 216 may charge a fee for the service. The level n+1 consumer 20 accesses preview files by signing onto the vendor server's 216 website and accessing his assigned storage area on the vendor server 216.

It is to be understood that instead of receiving assigned codes, the purchase software module and/or the transfer software module 460 executed by each consumer server 20 may randomly generate for itself the consumer ID IDnnnn, the consumer's public key Knnnn_{pub}, and/or the consumer's private key Knnnnₚᵣᵥ, as is known in the art.

It is contemplated that a level 2 consumer 20 may market a product without purchasing it, and be rewarded with commission for successful sales and resales of the product.

It is contemplated that the product database includes product history data for each product for storing data such as a tally of the number of sales made of the product. The product history data is updated upon a sale of the product.

It is contemplated that selected consumers 20 may operate as a distributed copyright owner of selected products, thus, providing a distributed system in which a central copyright owner is in communication with one or more distributed copyright owners. A distributed copyright owner may own a full or partial copyright of the products it distributes, or function as a distributor of the products, comparable to a retail store selling merchandise. The distributed copyright owner may be responsible for maintaining the MLM business model and providing associated services to consumers that branch of thereof, similar to the service provided by the copyright owner 16 to the consumers 20 of FIG. 1. Services, such as providing software, receiving payments for sales of products, paying commission to consumers 20 that market the products, and providing decryption keys to consumers that have made a purchase may be distributed between the central copyright owner and the distributed copyright owners. Alternatively, distributed copyright owners may become part of the MLM business model by becoming special users receiving higher commissions.

While the invention has been described with respect to specific embodiments by way of illustration, many modifications and changes will be apparent to those skilled in the art. It is therefore, to be understood that the appended claims are intended to cover all such modifications and changes as fall within the true spirit and scope of the invention.

What is claimed:

1. A method for tracking marketers of a digital product comprising the steps of:
storing user data associated with a plurality of registered users, wherein said user data includes a user identification code (userID) and payment information corresponding to each registered user of the plurality of registered users;
transferring a data packet associated with the digital product from a registered user of the plurality of registered users to another user, wherein the data packet includes a watermark storing the userID of the registered user;
transacting a purchase by the user of the digital product; and
processing the payment information corresponding to the registered user who transferred the data packet for effecting payment to the registered user for the sale of the digital product by the registered user to the user.

2. The method of claim 1, wherein the step of transferring further includes the step of updating the watermark to include the userID of the registered user who transferred the data packet.

3. The method of claim 1, wherein the method is performed in accordance with a multi-level marketing business model.

4. The method of claim 1, wherein the data packet includes a product content file including the content of the product and a preview file including a sample of the content of the product, and wherein the watermark is embedded in the preview file.

5. The method of claim 1, wherein the data packet includes a product content file, wherein the watermark is embedded in the product content file.

6. The method of claim 1, wherein a portion of the data packet is encrypted, and wherein the step of transacting a purchase further includes the step of providing a key for decrypting the encrypted portion.

7. The method of claim 2, wherein the step of transacting a purchase further includes the step of transmitting the updated watermark.

8. The method of claim 2, wherein the step of processing the payment further includes the step of receiving the updated watermark.

9. The method of claim 4, wherein the product content file is encrypted.

10. The method of claim 4, wherein the preview file is not encrypted.

11. The method of claim 5, wherein the data packet is secured for preventing use of the product by the user prior to receiving the key for decrypting.

12. A method for tracking marketers of a digital product comprising the steps of:
updating history data stored within a watermark associated with a digital product every time the digital product is transferred, wherein the history data includes data associated with individuals who have transferred the digital product to another individual;
accessing the history data;
transacting a sale of the digital product; and
rewarding the individuals who have transferred the digital product to another individual for effecting a sale of the digital product.

13. The method of claim 12, wherein the method is in accordance with a multi-level marketing business model.

14. A vendor server for tracking marketers of a digital product, said vendor server comprising a processor executing computer code for performing functions including:
storing user data associated with a plurality of registered users, wherein said user data includes a user identification code (userID) and payment information corresponding to each registered user of the plurality of registered users;
receiving watermark history data associated with a product, the watermark history data including the userID corresponding to registered users who have transferred a file associated with the product for marketing the product;
transacting a purchase of the product by a user; and
updating payment information corresponding to the registered users who have transferred the file.

15. The vendor server of claim 14, wherein the processor performs a further function including providing a decryption key for enabling the user to decrypt a product content file containing the content of the product.

16. A consumer server for tracking marketers of a digital product, said consumer server comprising a processor executing computer code for performing functions including:
receiving a data packet associated with a digital product marketed by a user of another processor, wherein the data packet includes a watermark storing history data including identification for each user that transferred the data packet to another user and a product content file;
transmitting the history data;
transacting a purchase of the digital product; and
receiving decryption data for decrypting the product content file.

17. The consumer server of claim 16, wherein the data packet further includes a preview file including a sample of the content of the product, and wherein the watermark is embedded in the preview file.

18. The consumer server of claim 16, wherein the product content file of the data packet is received in an encrypted form, and the preview file of the data packet is received in an unencrypted form.

19. The consumer server of claim 16, wherein the data packet is secured for preventing use of the product prior to receiving the key for decrypting.

20. The consumer server of claim 16, wherein the transmitted history data is encrypted.
